(19) United States
(12) Patent Application Publication
(10) Pub. No.: US 2026/0147304 A1
(43) Pub. Date: May 28, 2026

(54) IMAGE FORMING APPARATUS THAT FIXES IMAGE TO SHEET

(71) Applicant: CANON KABUSHIKI KAISHA, Tokyo (JP)

(72) Inventor: TAKAO IZAKI, Shizuoka (JP)

(21) Appl. No.: 19/177,813

(22) Filed: Apr. 14, 2025

(30) Foreign Application Priority Data
Apr. 22, 2024 (JP) 2024-069200

(51) Int. Cl. G03G 15/00; G03G 15/20

(52) U.S. Cl. CPC G03G 15/657; G03G 15/2017; G03G 15/2064; G03G 15/50; G03G 2215/00599; G03G 2215/00679; G03G 2215/2035

(57) ABSTRACT

An image forming apparatus obtains a temperature parameter from a first temperature detected by a sensor and a second temperature detected by the sensor after the detection of the first temperature, and controls a timing of feeding of a sheet by feeding rollers or a timing of forming an image by an image forming unit based on a result of judgement of the temperature parameter and a threshold value. The threshold value is determined according to the first temperature.

### BACKGROUND OF THE INVENTION

### Field of the Invention

The present invention relates to an image forming apparatus that fixes images to sheets.

### Description of the Related Art

To fix a toner image to a sheet, the temperature of a heating device must be accurately controlled to reach a target temperature. The time required for the temperature of the heating device to reach the target temperature varies according to the voltage supplied by the commercial AC power source. Japanese Patent Laid-Open No. 05-333944 proposes detecting a temperature gradient in order to estimate change in the power supplied to the fixing device that accompanies change in the voltage of the power source, and mitigate temperature overshooting.

In order to improve the productivity of an image forming apparatus, it is effective to start conveying a sheet and forming a toner image before the temperature of the heating device reaches the target temperature. However, if the sheet arrives at the heating device when the temperature of the heating device is below the target temperature, the toner image may fail to fix properly. Therefore, if the timing at which to start feeding the sheet is determined according to the temperature gradient, the productivity of the image forming apparatus will improve. However, since the temperature gradient varies according to the initial temperature of the temperature sensor, there has been room for improvement in the accuracy of determining the timing at which to start feeding a sheet based on the temperature gradient.

### SUMMARY OF THE INVENTION

The disclosure provides an image forming apparatus comprising: feeding rollers configured to feed a sheet; an image forming unit configured to form an image on the sheet; a fixing unit configured to fix the image to the sheet, the fixing unit including a first rotational member, a second rotational member in contact with the first rotational member to form a nip portion, and a heater configured to heat at least one of the first rotational member and the second rotational member; a sensor disposed in proximity to any of the first rotational member, the second rotational member, and the heater; and a controller configured to obtain a temperature parameter from a first temperature detected by the sensor and a second temperature detected by the sensor after the detection of the first temperature, and control a timing of feeding of the sheet by the feeding rollers or a timing of forming the image by the image forming unit based on a result of judgement of the temperature parameter and a threshold value determined according to the first temperature.

Further features of the present invention will become apparent from the following description of exemplary embodiments (with reference to the attached drawings).

### BRIEF DESCRIPTION OF THE DRAWINGS

FIG. 1 is a view illustrating an image forming apparatus.

FIG. 2 is a view illustrating a fixing device.

FIG. 3 is a view illustrating temperature transitions.

FIG. 4 is a view illustrating the relationship between initial temperatures and temperature differences.

FIG. 5 is a block diagram illustrating a controller.

FIG. 6 is a flowchart describing a control method.

FIG. 7 is a view illustrating the temperature transitions for corresponding combinations of heat capacities and voltages.

FIG. 8 is a view illustrating a method for correcting a threshold or a mathematical expression.

FIG. 9 is a block diagram illustrating a controller.

FIG. 10 is a flowchart illustrating a control method.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### 1. First Embodiment

### 1-1. Structure of Image Forming Apparatus

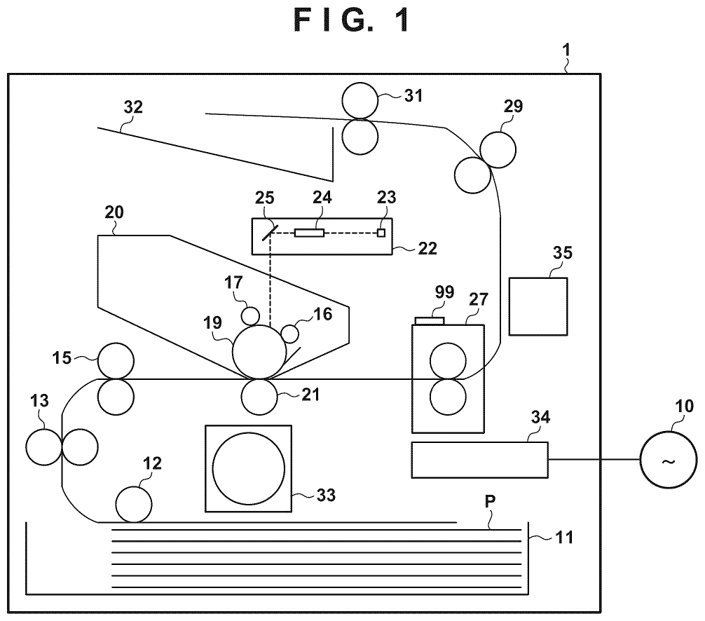

As shown in FIG. 1, an image forming apparatus 1 is a printer using electrophotographic recording technology. A sheet cassette 11 is a holding unit that holds a plurality of sheets P. The sheets P may also be referred to as recording paper, recording material, or transfer material. A pickup roller 12 feeds sheets S from the sheet cassette 11 one by one into a conveyance path. Feeding rollers 13 are conveyance rollers positioned downstream of the pickup roller 12 in the direction of conveyance of the sheets P. Registration rollers 15 are conveyance rollers that correct the skew of the sheets P and adjust the timing of conveyance further downstream.

A process cartridge 20 is an image forming unit that forms toner images to be transferred to the sheets P. The process cartridge 20 includes a charger 16, a developing roller 17, and a photoconductor drum 19. The charger 16 is a charging roller or a charging wire that charges the surface of the photoconductor drum 19. An exposure unit 22 is an exposure light source that irradiates the surface of the photoconductor drum 19 with laser light to form an electrostatic latent image. The developing roller 17 develops the electrostatic latent image using toner contained in a toner container to form the toner image. The photoconductor drum 19 rotates to convey the toner image to a transfer nip. The transfer nip is formed by the photoconductor drum 19 and a transfer roller 21 coming into contact with each other. As a sheet P passes through the transfer nip, the toner image is transferred from the photoconductor drum 19 to the sheet P.

The exposure unit 22 includes a laser diode 23, a polygon mirror 24, and a reflecting mirror 25. The laser diode 23 is a light source that emits laser light corresponding to an image signal. The laser diode 23 may be a light emitting diode. The polygon mirror 24 rotates to scan the laser light across the surface of photoconductor drum 19. The reflecting mirror 25 is an optical component that further directs the light from the polygon mirror 24 to the surface of the photoconductor drum 19.

The photoconductor drum 19 and the transfer roller 21 rotate to convey the sheet P further downstream. A heating device (a fixing device 27) is located downstream of the transfer nip. The fixing device 27 applies heat and pressure to the sheet P and the toner image to fix the toner image to the sheet P.

Conveyance rollers 29 located downstream of the fixing device 27 convey the sheet P to discharge rollers 31. The discharge rollers 31 convey and discharge the sheet P to a discharge tray 32 provided on the top surface of the image forming apparatus 1.

A motor 33 provides driving force to a plurality of rotational members, including the pickup roller 12, the fixing device 27, and the photoconductor drum 19. A power unit 34 includes a power circuit that converts the voltage supplied from an AC power supply 10 to a DC voltage for the image forming apparatus 1. The AC power supply 10 is, for example, a commercial AC power source. A controller 35 operates on power supplied from the power unit 34 to control each component of the image forming apparatus 1 (e.g., the motor 33, the exposure unit 22, and the fixing device 27). Although only one motor 33 is shown in the figure, a plurality of motors may also be employed. An actuator, such as a solenoid, may also be employed to lower the pickup roller 12 into contact with the sheet P.

The fixing device 27 may have a nonvolatile memory 99. The nonvolatile memory 99 may have stored therein unit-specific individual information acquired during the manufacturing process of the fixing device 27. As described in a second embodiment, the individual information may be, for example, information about the heat capacity of the fixing device 27.

### 1-2. Structure of Fixing Device

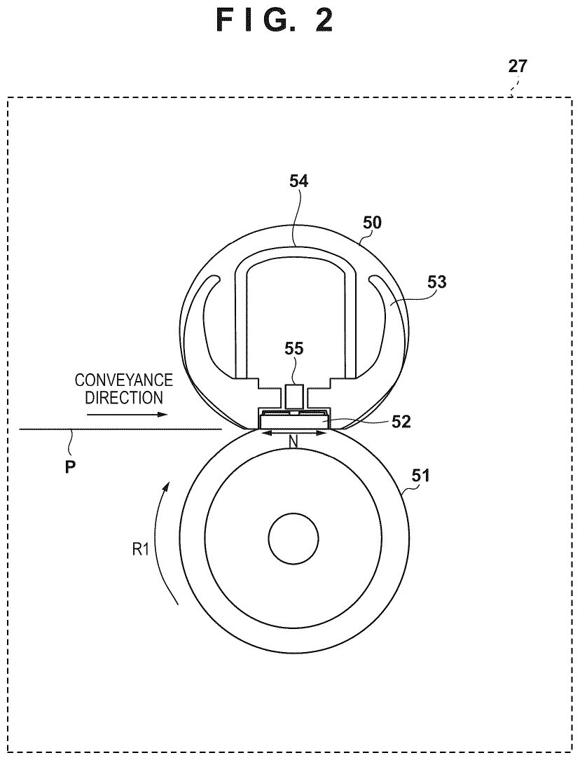

As shown in FIG. 2, the fixing device 27 includes a fixing film 50, a pressure roller 51, a heater 52, a heater holder 53, a pressure stay 54, and a temperature sensor (hereinafter referred to as a thermistor 55). The fixing film 50 is a flexible cylindrical (i.e., endless) film-like member. A smaller heat capacity of the fixing film 50 is advantageous for shortening the FPOT (first printout time). For this reason, the fixing film 50 is made thinner. The pressure roller 51 is a pressure member that contacts and rotates with the fixing film 50. The pressure roller 51 is disposed to oppose the heater 52 across the fixing film 50. The heater 52 is a heating member (a heating element) that heats the fixing film 50. The heater 52 is a plate-shaped heating member in contact with the inner circumferential surface of the fixing film 50 to rapidly heat the fixing film 50. The heater 52 includes, for example, an insulating ceramic substrate made of alumina or aluminum nitride, among others. The heater 52 may be a halogen heater or an induction heater. The temperature of the heater 52 is detected by the thermistor 55 attached to the back surface of the ceramic substrate. The thermistor 55 may be disposed in proximity to any of the fixing film 50, the pressure roller 51, or the heater 52. In this embodiment, a contact type thermistor is employed as the thermistor 55. A non-contact thermistor may alternatively be employed as the thermistor 55. The heater holder 53 is disposed in the inner space of the fixing film 50 to hold the heater 52. The pressure stay 54 is made of a rigid material, such as metal. The pressure stay 54 is subjected to the pressure from a pressure member, such as a spring (not shown). As a result, the pressure stay 54 applies pressure to the pressure roller 51 via the heater holder 53. The pressure roller 51 is rotatably driven by the motor 33 to rotate in the direction indicated by the arrow R1 (i.e., clockwise). The fixing film 50 is rotatably driven by the pressure roller 51. As a result, the sheet P is conveyed in the direction indicated by the straight arrow. The area where the heater 52 and the pressure roller 51 are in contact with each other is referred to as the nip portion N.

### 1-3. Temperature Transition

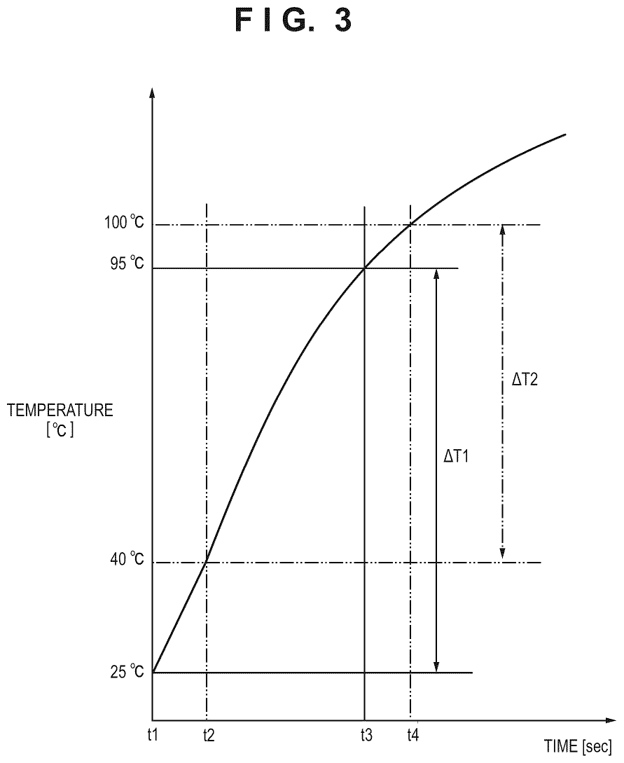

FIG. 3 shows the temperature transition detected by the thermistor 55 (hereafter referred to as the start-up temperature curve) when the AC voltage supplied by the AC power supply 10 is 100 V AC. The vertical axis indicates a temperature difference ΔT. The horizontal axis indicates time. The temperature difference ΔT is the difference between the initial temperature and the temperature at a second timing after a predetermined time has elapsed from a first timing at which the initial temperature was clocked. The temperature difference ΔT is a temperature parameter that indicates the rate of temperature rise or the speed of temperature rise in the predetermined time.

For example, the time from time t1 to time t3 and the time from time t2 to time t4 are 2.0 seconds each. In this embodiment, a case in which the initial temperature of the thermistor 55 is 25° C. and a case in which the initial temperature is 40° C. are assumed.

When the initial temperature detected by the thermistor 55 is 25° C. (at time t1), power supply to the heater 52 is started. Thereafter, the temperature T detected by the thermistor 55 rises. At time t3, the temperature T detected by the thermistor 55 reaches 95° C. The temperature difference ΔT1 at this time is the difference between the detected temperature T at time t3 and the detected temperature T at time t1 (ΔT1=95° C.−25° C.=70° C.).

In the case where power supply to the heater 52 is started when the initial temperature of the thermistor 55 is 40° C. (at time t2), the detected temperature T of the thermistor 55 reaches 100° C. at time t4. The temperature difference ΔT2 is 60° C. In this embodiment, the type of thermistor 55 is an NTC type with a negative temperature coefficient. Generally, once electric power is applied to the heater 52, the heater 52 generates and dissipates heat therefrom. When a certain amount of electric power is applied to the heater 52, a certain amount of heat is generated. However, the higher the temperature, the greater the amount of heat dissipated. Therefore, the temperature transition forms a curve.

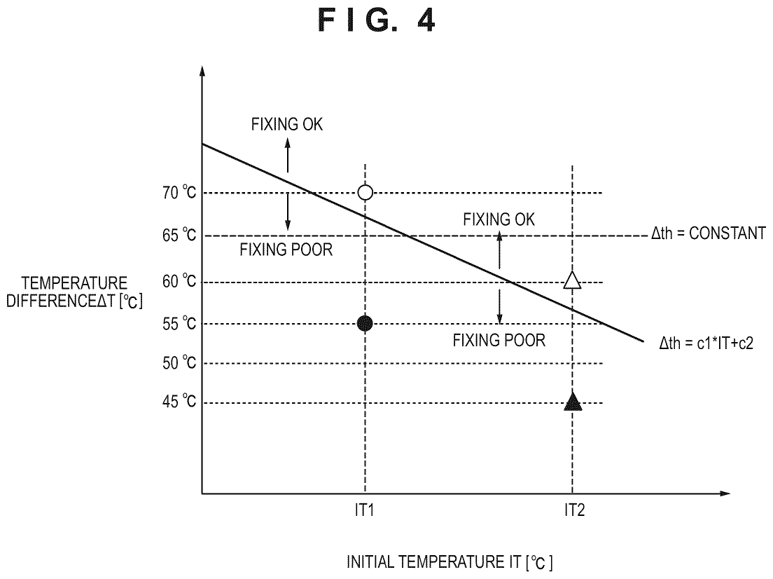

FIG. 4 is a graph showing the initial temperature of the thermistor 55 and the temperature difference ΔT. The vertical axis indicates the temperature difference ΔT. The horizontal axis indicates the initial temperature. As described above, the temperature difference ΔT indicates the temperature difference at a fixed time (2.0 seconds). The white circle and the white triangle indicate points where no image defects occurred (“OK”). The black circle and the black triangle indicate points where image defects occurred (“POOR”).

Generally, the cause of image defects is that the temperature of the nip portion N in the fixing device 27 has not reached the temperature suitable for fixing a tone image to the sheet P. In other words, image defects occur when the power necessary for fixing the toner image to the sheet P is not supplied.

In this embodiment, it is assumed that the initial temperature IT1 of the thermistor 55 is 25° C. and that the initial temperature IT2 of the thermistor 55 is 40° C. The voltage of the AC power supply 10 is 100 V AC.

When the supply of power to the heater 52 was started at the initial temperature of the thermistor 55 of 25° C., the temperature difference ΔT reached 70° C. (indicated by the white circle). When the supply of power to the heater 52 was started at the initial temperature of the thermistor 55 of 40° C., the temperature difference ΔT reached 60° C. (indicated by the white triangle).

On the other hand, when the voltage of the AC power supply 10 was set to 85 V AC and the initial temperature of the thermistor 55 was 25° C., the temperature difference ΔT reached 55° C. (indicated by the black circle). When the initial temperature of the thermistor 55 was 40° C., the temperature difference ΔT reached 45° C. (indicated by the black triangle).

As shown in FIG. 4, Δth is a threshold value for judging whether an image defect has occurred. In other words, Δth can be used as a threshold for judging whether the fixing device 27 is ready for fixing operation. Δth may be obtained, for example, by the equation below:

$$Δ t h = c 1 \times IT + c 2 \qquad Equation 1$$

where IT represents the initial temperature and c1 and c2 are coefficients that depend on the structure of the fixing device 27, among other factors. For example, c1 is −0.67 and c2 is 85. Thus, Equation 1 is an example of a mathematical expression where a temperature is the input value and a threshold is the output value.

The solid line shown in FIG. 4 corresponds to Equation 1. By using Equation 1, the threshold value Δth is determined according to the initial temperature IT in the case where the voltage of the AC power supply 10 is 100 V AC.

### 1-4. Controller

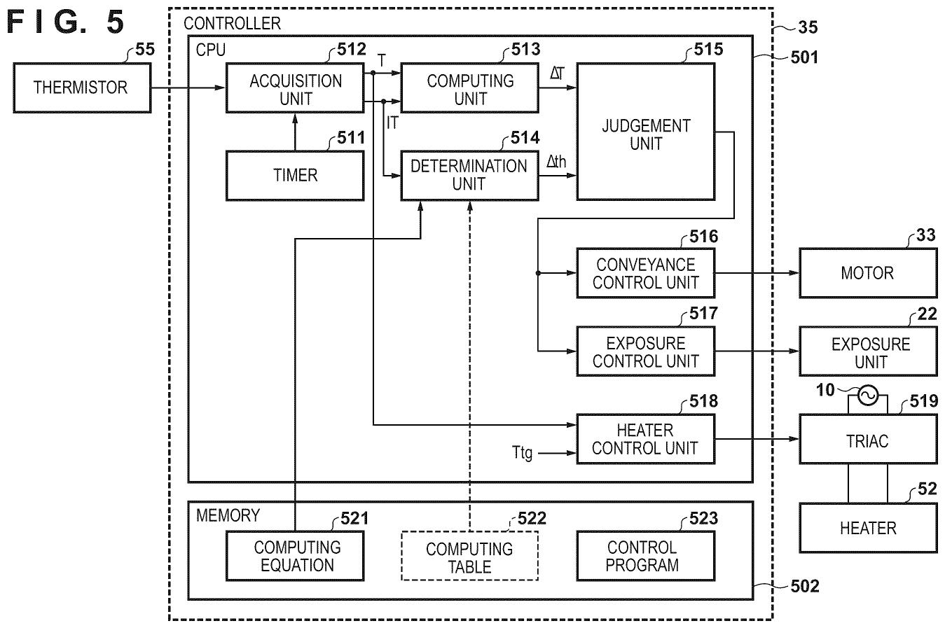

FIG. 5 shows the functions of the controller 35 that controls the timing for feeding a sheet or the timing for forming an image. The CPU 501 is a processor that performs various functions by executing the control program 523 stored in a memory 502. One or more of the functions may be realized by an integrated circuit (IC) separated from the CPU 501. The memory 502 is a storage unit that includes a nonvolatile memory (a ROM area) and a volatile memory (a RAM area). The nonvolatile memory 99 may be part of the memory 502.

An acquisition unit 512 acquires the temperature T of the heater 52 (e.g., the initial temperature IT) based on a detection signal generated by the thermistor 55. A determination unit 514 determines the threshold value Δth corresponding to the initial temperature IT by referring to a computing equation 521 or a computing table 522 based on the initial temperature IT. The computing equation 521 is, for example, Equation 1. The computing table 522 stores a threshold value Δth obtained in advance for each of a plurality of initial temperatures. In other words, the initial temperatures are associated with the threshold values Δth on a one-to-one basis. The acquisition unit 512 may read, from the computing table 522, the Δth that corresponds to the initial temperature IT acquired by the thermistor 55. The nonvolatile memory 99 may have the computing equation 521 or the computing table 522 stored therein. The computing equation 521 or the computing table 522 may also be part of a control program 523. Thus, the computing table 522 may hold a plurality of pairs of initial temperatures IT and threshold values Δth.

A timer 511 is used to identify the second timing at which a predetermined time (e.g., 2.0 seconds) has elapsed from the first timing at which the initial temperature IT was acquired. The acquisition unit 512 acquires the temperature T based on the timer 511 and transmits it to the computing unit 513. The computing unit 513 computes a temperature difference ΔT based on the temperature T and the initial temperature IT, and a judgement unit 515 judges whether the temperature difference ΔT has exceeded the threshold value Δth. Alternatively, the judgement unit 515 may judge whether the temperature difference ΔT is greater than or equal to the threshold value Δth. In this specification, the judgement of whether a value has exceeded the threshold value may be replaced by the judgement of whether a value is greater than or equal to the threshold value. The judgement of whether a value is below the threshold value may be replaced by the judgement of whether a value is less than or equal to the threshold value. If the temperature difference ΔT has exceeded the threshold value Δth, the fixing device 27 is ready (in a fixing ready state). As used herein, “the fixing device 27 is ready” means that the temperature T of the heater 52 will have reached the target temperature Ttg by the time the sheet P arrives at the fixing device 27. Therefore, the temperature T of the heater 52 does not yet have to reach the target temperature Ttg at the start of the feeding of the sheet P.

A conveyance control unit 516 activates the motor 33 to start feeding the sheet P according to the result of the judgement by the judgement unit 515. For example, if the temperature difference ΔT has exceeded the threshold value Δth, the conveyance control unit 516 immediately starts feeding the sheet P. If the temperature difference ΔT has not exceeded the threshold value Δth, the conveyance control unit 516 stands by until the temperature T is higher than or equal to the target temperature Ttg before starting to feed the sheet P. In this way, the conveyance control unit 516 may stand by until the detected temperature Tis higher than or equal to the predetermined value before starting to feed the sheet P.

An exposure control unit 517 causes the exposure unit 22 to start generating laser light according to the result of the judgement by the judgement unit 515. For example, if the temperature difference ΔT has exceeded the threshold value Δth, the exposure control unit 517 causes the exposure unit 22 to immediately start generating laser light. If the temperature difference ΔT has not exceeded the threshold value Δth, the exposure control unit 517 stands by until the temperature T is higher than or equal to the target temperature Ttg before causing the exposure unit 22 to start outputting the laser light. Thus, the exposure control unit 517 may stand by until the detected temperature T is higher than or equal to the predetermined value before starting image formation.

A heater control unit 518 controls the power supplied from the AC power supply 10 to the heater 52. For example, the heater control unit 518 turns on/off a triac 519 so that the temperature T reaches the target temperature Ttg. The triac 519 is a semiconductor switching element that can switch between supplying and cutting off the AC voltage.

### 1-5. Flowchart

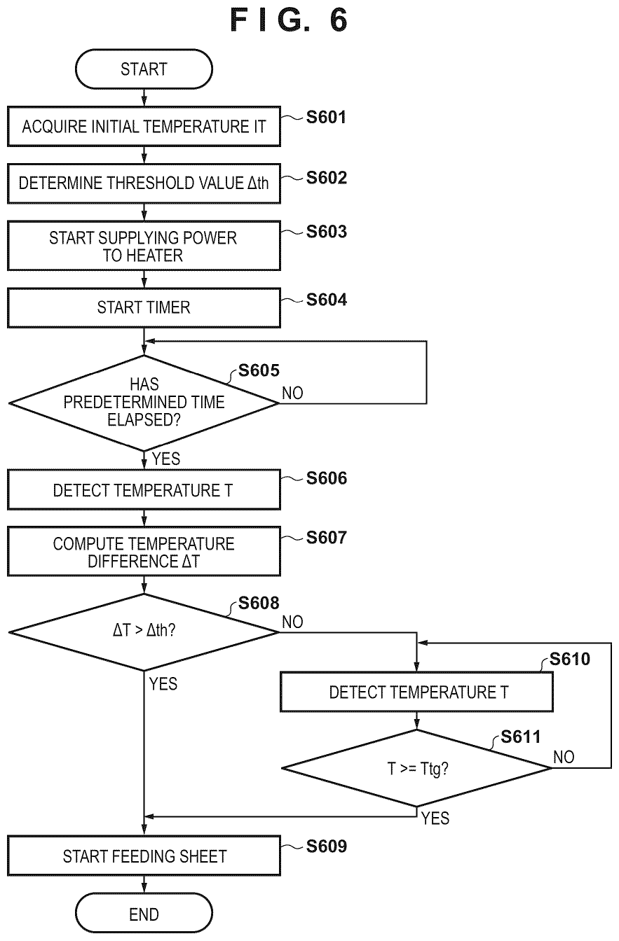

FIG. 6 is a flowchart showing the control method according to the first embodiment. The CPU 501 performs the process described below according to the control program 523.

In step S601, the CPU 501 (the acquisition unit 512) acquires the initial temperature IT of the heater 52 using the thermistor 55. The initial temperature IT may be stored in the RAM area of the memory 502.

In step S602, the CPU 501 (the determination unit 514) determines a threshold value Δth based on the initial temperature IT. For example, the determination unit 514 determines the threshold value Δth in accordance with the initial temperature IT using the computing equation 521 or the computing table 522.

In step S603, the CPU 501 (the heater control unit 518) starts supplying power to the heater 52. The heater control unit 518 turns on the triac 519 (i.e., brings the triac 519 into conduction).

In step S604, the CPU 501 starts the timer 511. In step S605, the CPU 501 judges, based on the clock value of the timer 511, whether a predetermined time has elapsed since the timing of the clocking of the initial temperature IT. If the predetermined time has elapsed, the CPU 501 advances the process from step S605 to step S606.

In step S606, the CPU 501 (the acquisition unit 512) acquires the temperature T from the thermistor 55. The temperature T may also be temporarily stored in memory 502.

In step S607, the CPU 501 (the computing unit 513) computes the temperature difference ΔT based on the temperature T and the initial temperature IT. In step S608, the CPU 501 (the judgement unit 515) judges whether the temperature difference ΔT has exceeded the threshold value Δth. If the temperature difference ΔT has exceeded the threshold value Δth, the CPU 501 advances the process from step S608 to step S609. In step S609, the CPU 501 (the conveyance control unit 516) starts feeding the sheet P by causing the motor 33 to rotate the pickup roller 12. Alternatively, the conveyance control unit 516 may also start feeding the sheet P by lowering the pickup roller 12 already in rotation using a solenoid (not shown). If it is judged in step S608 that the temperature difference ΔT has not exceeded the threshold value Δth, the CPU 501 advances the process from step S608 to step S610.

In step S610, the CPU 501 (the acquisition unit 512) acquires the temperature T from the thermistor 55. In step S611, the CPU 501 (the judgement unit 515) judges whether the temperature T is higher than or equal to the target temperature Ttg. When the temperature T is higher than or equal to the target temperature Ttg, the CPU 501 advances the process from step S611 to step S609. In step S609, the CPU 501 (the conveyance control unit 516) starts feeding the sheet P by causing the motor 33 to rotate the pickup roller 12.

According to the first embodiment, by determining the threshold value Δth based on the initial temperature IT, it is possible to make the fixing of the toner image to the sheet P compatible with the productivity of the image forming apparatus 1. In FIG. 6, the timing of feeding the sheet P is controlled based on the temperature T. However, this is only one example. There is also an image forming apparatus 1 where the exposure unit 22 starts exposure earlier than the feeding of the sheet P. In this case, the exposure is started in step S609 and then the feeding is started. Although this embodiment describes an example in which the timing at which to start feeding a sheet or the timing at which to start exposure is controlled based on a comparison between the temperature difference ΔT and the threshold value Δth, the timing at which to start feeding or the timing at which to start exposure may be controlled based on a comparison between the temperature T detected after predetermined timing and a threshold value.

Note that the temperature difference ΔT depends on the initial temperature IT and the level of the AC voltage supplied from the AC power supply 10 (i.e., the power supply capacity of the AC power supply 10). There are regions where the supply capacity of the AC power supply 10 is not necessarily constant. For an image forming apparatus 1 installed in such a region, it is possible to estimate the power supply capacity of the AC power supply 10 based on the temperature transition of the thermistor 55. In other words, it is possible to estimate the power supply capacity of the AC power supply 10 without detecting the voltage of the AC power supply 10. If the AC power supply 10 has sufficient power supply capacity, it is possible to start feeding the sheet P early. If the AC power supply 10 does not have sufficient power supply capacity, the start of the feeding of the sheet P is delayed to ensure sufficient fixing performance. Thus, the temperature difference ΔT may be understood as a temperature parameter indicating the power supply capacity of the AC power supply 10.

### 2. Second Embodiment

The second embodiment is directed to a method for determining a threshold value Δth by factoring in unit-specific individual differences (unit-specific variations) of the fixing device 27. In the following description of the second embodiment, the description of the first embodiment applies to matters common to the first embodiment.

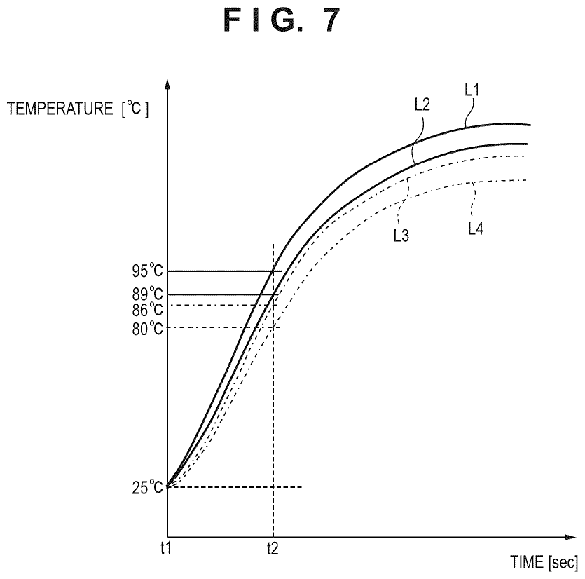

FIG. 7 shows the temperature transitions of the fixing device 27 according to the different voltages and heat capacities of the AC power supply 10. The vertical axis indicates temperature. The horizontal axis indicates time. The area of the nip portion N changes depending on variations in the hardness and thickness of the pressure roller 51. Furthermore, the heat capacity of the fixing device 27 is subject to change depending on the area of the nip portion N. Therefore, unit-specific individual differences of the fixing device 27 result in variations in heat capacity.

The time interval from time t1 to time t2 is, for example, 2.0 seconds. The initial temperature IT of the thermistor 55 is assumed to be 25° C.

L1 indicates the case in which the voltage of the AC power supply 10 is 100 V AC and the heat capacity of the fixing device 27 is HC1. L2 indicates the case in which the voltage of the AC power supply 10 is 90 V AC and the heat capacity of the fixing device 27 is HC1. L3 indicates the case in which the voltage of the AC power supply 10 is 100 V AC and the heat capacity of the fixing device 27 is HC2. HC2 is greater than HC1. L4 indicates the case in which the voltage of the AC power supply 10 is 90 V AC and the heat capacity of the fixing device 27 is HC2. The greater the heat capacity of an object, the more difficult it is for the temperature of that object to rise.

As indicated by L1, 2.0 seconds after applying a voltage of 100 V AC to the heater 52, the detected temperature T of the thermistor 55 reached 95° C. As indicated by L2, 2.0 seconds after applying a voltage of 90 V AC to the heater 52, the detected temperature T of the thermistor 55 reached 89° C. Thus, if the heat capacities are equal, the higher the voltage of the AC power supply 10 (i.e., the more power), the faster the temperature T can reach the predetermined temperature.

As indicated by L3, 2.0 seconds after applying a voltage of 100 V AC to the heater 52, the detected temperature T of the thermistor 55 reached 86° C. As indicated by L4, 2.0 seconds after applying a voltage of 90 V AC to the heater 52, the detected temperature T of the thermistor 55 reached 80° C. Thus, if the heat capacities are equal, the higher the voltage of the AC power supply 10 (i.e., the more power), the faster the temperature T can reach the predetermined temperature.

A comparison between L1 and L3 shows that, for the same power, the smaller the heat capacity, the faster the temperature T can rise, and a comparison between L2 and L4 suggests a similar phenomenon.

A comparison between L2 and L3 shows that L2 can reach the predetermined temperature faster than L3. In other words, the contribution of heat capacity to the slope of temperature T may be greater than the contribution of voltage to the slope of temperature T. In a group of units of the fixing device 27 with large variations in heat capacity, these variations have a significant impact on the determination of the start of feeding. Therefore, if the threshold value Δth is determined by also factoring in the heat capacity, the accuracy of determining the start of feeding would be improved. As described above, the determination of the start of feeding is a concept that is interchangeable with the determination of the start of exposure.

Therefore, in the second embodiment, in order to discriminate between L2 and L3, data for correcting the unit-specific variation of heat capacity is acquired in the inspection process of the fixing device 27 and stored in the nonvolatile memory 99. The CPU 501 reads the data from the nonvolatile memory 99 and corrects Equation 1, among others, for determining the threshold value Δth.

### 2-1. Acquisition of Individual Information (Correction Data)

The fixing device 27 is mass-produced in a factory. During the inspection process of the fixing device 27, the fixing device 27 is set in an inspection device and is supplied with AC voltage from an AC power source (not shown) external to the fixing device 27. The AC voltage supplied to the fixing device 27 is, for example, 100 V AC (i.e., the reference voltage). The reference voltage is usually the nominal voltage of the commercial AC power source at the destination of the fixing device 27.

Power supply to the fixing device 27 is started when the initial temperature IT of the thermistor 55 is 25° C. When 2.0 seconds have elapsed since the start of power supply, temperature T is acquired by the thermistor 55. The individual temperature difference ΔTF is calculated as the difference between the temperature T and the initial temperature IT. The individual temperature difference ΔTF is written to the nonvolatile memory 99 by a ROM writer.

### 2-2. Correction Method

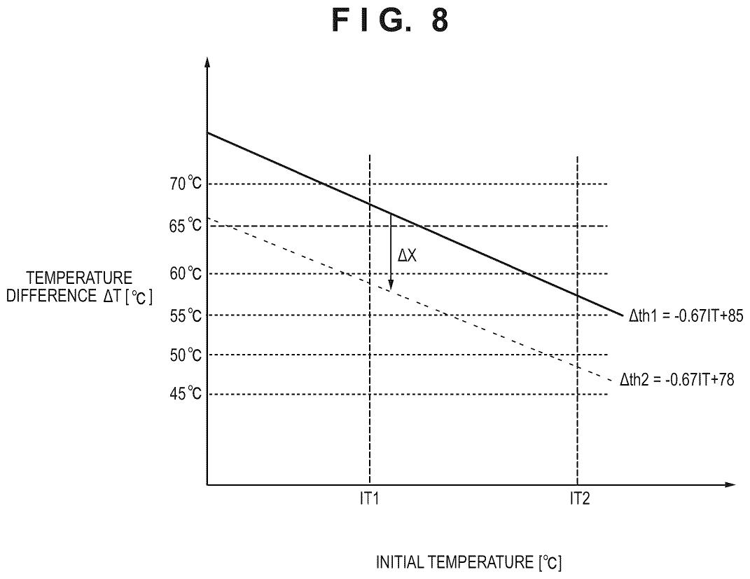

FIG. 8 shows the relationship between the initial temperature IT and the temperature difference ΔT. Δth1 represents the threshold value acquired by supplying the reference voltage (e.g., 100 V AC) to a standard individual (of the fixing device 27). The standard individual may also be referred to as the reference fixing unit. The standard individual temperature difference (i.e., reference information) is denoted as ΔTB. As described above, the threshold value Δth is obtained from Equation 1. In FIG. 8, the coefficient c1 of Δth1 is −0.67. The coefficient c2 is 85. All numerical values appearing herein are only examples.

Δth2 indicates the threshold value acquired by supplying the reference voltage (e.g., 100 V AC) to the fixing device 27 whose individual temperature difference is ΔTF. According to one example shown in FIG. 8, the heat capacity of the fixing device 27 corresponding to Δth2 is larger than that of the fixing device 27 corresponding to Δth1.

The temperature difference ΔT of the fixing device 27 corresponding to Δth2 is smaller than the temperature difference ΔT of the fixing device 27 corresponding to Δth1 by ΔX. ΔX is also the difference between ΔTB and ΔTF. Therefore, correcting Equation 1 with ΔX reduces the influence of individual differences that depend on differences in heat capacity on the threshold value Δth.

$$Δ t h = c 1 \times IT + c 2 + Δ X \qquad Equation 2$$

In this example, ΔTF is 61° C. and ΔTB is 68° C. Therefore, ΔX is −7° C. The CPU 501 can acquire Δth2 by adding −7 to Δth1. This is equivalent to correcting the addition coefficient c2 in Equation 1 with ΔX to acquire Equation 2.

### 2-3. Controller

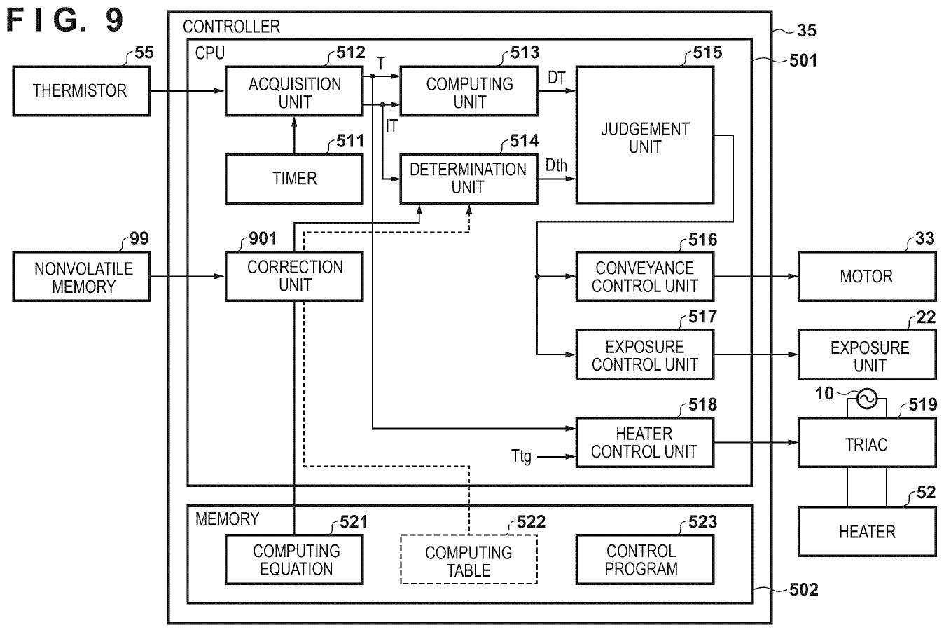

FIG. 9 shows the controller 35 of the second embodiment. A correction unit 901 of the CPU 501 reads ΔTF and ΔTB from the nonvolatile memory 99 to obtain a correction value ΔX. Note that the previously obtained correction value ΔX may alternatively be stored in the nonvolatile memory 99. The correction unit 901 corrects the computing equation 521 (Equation 1) with the correction value ΔX to determine Equation 2 and passes Equation 2 to the determination unit 514. Alternatively, the correction unit 901 may use the correction value ΔX to correct Δth1, which is acquired from the computing table 522 based on the initial temperature IT, to determine Δth2 and pass Δth2 to the determination unit 514.

### 2-4. Flowchart

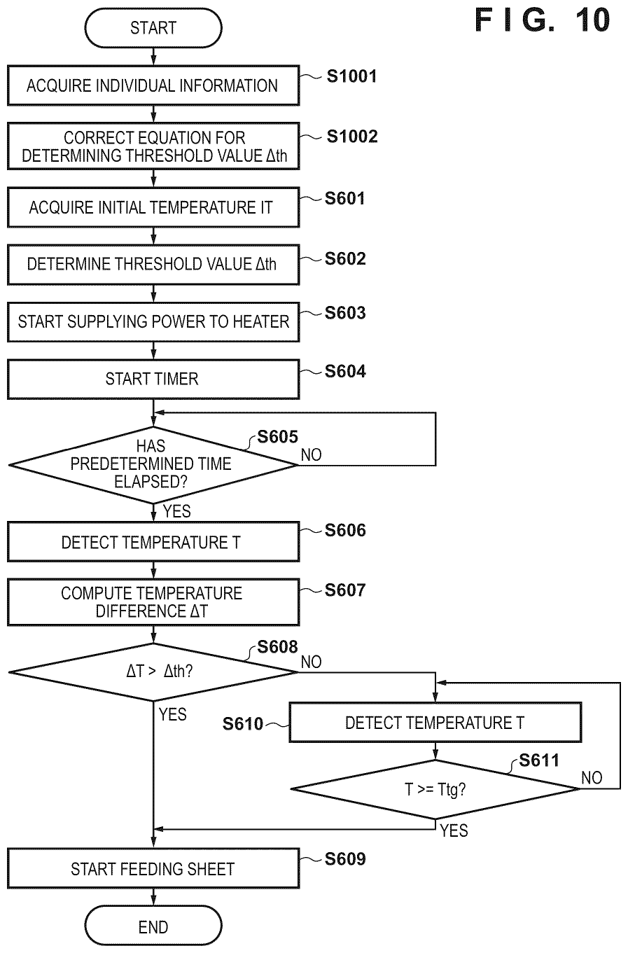

FIG. 10 shows a control method according to the second embodiment. The CPU 501 performs the process described below according to the control program 523 stored in the memory 502.

In step S1001, the CPU 501 (the correction unit 901) acquires individual information (correction data ΔX) from the nonvolatile memory 99 of the fixing device 27.

In step S1002, the CPU 501 (the correction unit 901) corrects the computing equation 521 (Equation 1) for determining the threshold value Δth. As a result, Equation 1 is corrected to become Equation 2. Thereafter, the CPU 501 executes steps S601 through S611. In step S602, however, Δth is determined using Equation 2. Note that, steps S1001 and S1002 may alternatively be executed within step S602.

The second embodiment can achieve the same effect as the first embodiment. Furthermore, the second embodiment can determine the threshold value Δth more precisely than the first embodiment. Therefore, the second embodiment will further improve the fixing of toner images and the productivity of the image forming apparatus 1.

### Additional Notes

The controller 35 determines the threshold value Δth for controlling the timing for feeding a sheet P or the timing for forming an image based on the initial temperature IT. The threshold value Δth is determined based on the rate of increase of the temperature T according to the power supply capacity of the AC power supply 10. As a result, both the fixing of the toner image to the sheet P and the productivity of the image forming apparatus 1 are mutually compatible.

Equations 1 and 2 are examples of mathematical expressions.

The memory 502 and the nonvolatile memory 99 are examples of a first memory unit.

The memory 502 and the nonvolatile memory 99 are examples of a second memory unit. In this way, the timing for feeding a sheet P or the timing for forming an image can be more accurately determined by correcting a mathematical expression based on a correction value attributable to individual differences, among others.

The controller 35 may also determine the threshold value Δth2 by correcting the threshold value Δth1 determined by Equation 1 with the correction value ΔX. Correcting the mathematical expression and correcting the threshold value calculated by the mathematical expression are substantially the same.

As described in the second embodiment, ΔTF (individual information) may be stored in the nonvolatile memory 99. In this case, ΔTB (reference information) may additionally be used to compute the correction value ΔX. The reference fixing unit may be a standard fixing device 27 used to acquire ΔTB. As used herein, a standard fixing device 27 may also be a fixing device 27 with a standard heat capacity among a large number of fixing devices 27 mass-produced at a manufacturing plant.

The computing table 522 may hold a plurality of pairs of initial temperatures IT and threshold values Δth.

The threshold value Δth1 acquired from the computing table 522 may be corrected with the correction value ΔX.

The correction value ΔX may be obtained from ΔTB (the reference information) and ΔTF (the individual information).

If the power supplied by the AC power supply 10 is in good condition, sheet feeding may start at a first timing. This improves the productivity of the image forming apparatus 1, while maintaining high fixing performance. If the power supply of the AC power supply 10 is less than satisfactory, feeding or exposure may be started at a second timing. This maintains sufficient fixing performance.

If the power supply of the AC power supply 10 is in good condition, exposure may start at a first timing. This improves the productivity of the image forming apparatus 1 while maintaining fixing performance. If the power supply of the AC power supply 10 is less than satisfactory, feeding or exposure may be started at a second timing. This maintains sufficient fixing performance.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-069200, filed Apr. 22, 2024 which is hereby incorporated by reference herein in its entirety.

1. An image forming apparatus comprising:
feeding rollers configured to feed a sheet;
an image forming unit configured to form an image on the sheet;
a fixing unit configured to fix the image to the sheet, the fixing unit including
a first rotational member,
a second rotational member in contact with the first rotational member to form a nip portion, and
a heater configured to heat at least one of the first rotational member and the second rotational member;
a sensor disposed in proximity to any of the first rotational member, the second rotational member, and the heater; and
a controller configured to obtain a temperature parameter from a first temperature detected by the sensor and a second temperature detected by the sensor after the detection of the first temperature, and control a timing of feeding of the sheet by the feeding rollers or a timing of forming the image by the image forming unit based on a result of judgement of the temperature parameter and a threshold value determined according to the first temperature.

2. The image forming apparatus according to claim 1, wherein the controller is further configured to acquire the threshold value corresponding to the first temperature using a mathematical expression in which a temperature is an input value and a threshold value is an output value.

3. The image forming apparatus according to claim 2, wherein the mathematical expression outputs the threshold value corresponding to the first temperature by adding a second coefficient to a product of a predetermined first coefficient and the first temperature.

4. The image forming apparatus according to claim 2, further comprising:
a first memory configured to store the mathematical expression,
wherein the controller is further configured to acquire the mathematical expression from the first memory.

5. The image forming apparatus according to claim 4, wherein the first memory is provided in the fixing unit.

6. The image forming apparatus according to claim 2, further comprising:
a second memory configured to store in advance a correction value for correcting the mathematical expression,
wherein the controller is further configured to acquire the correction value from the second memory, determine the threshold value based on the mathematical expression corrected with the correction value, and compare the determined threshold value with the temperature parameter.

7. The image forming apparatus according to claim 2, further comprising:
a second memory configured to store in advance a correction value for correcting the threshold value acquired using the mathematical expression,
wherein the controller is further configured to acquire the correction value from the second memory and compare the threshold value corrected with the correction value and the temperature parameter.

8. The image forming apparatus according to claim 2, further comprising:
a second memory configured to store in advance individual information acquired during manufacturing of the fixing unit,
wherein the controller is further configured to determine a correction value based on reference information that serves as a reference for heat capacity and is acquired from a reference fixing unit and based on the individual information acquired from the second memory, correct the mathematical expression with the correction value, and compare a threshold value determined using the corrected mathematical expression with the temperature parameter.

9. The image forming apparatus according to claim 6, wherein the second memory is provided in the fixing unit.

10. The image forming apparatus according to claim 1, further comprising:
a first memory configured to store a plurality of pairs of temperatures and threshold values,
wherein the controller is further configured to acquire, from the first memory, the threshold value corresponding to the first temperature.

11. The image forming apparatus according to claim 10, wherein the first memory is provided in the fixing unit.

12. The image forming apparatus according to claim 10, further comprising:
a second memory configured to store in advance a correction value for correcting the threshold value,
wherein the controller is further configured to acquire the correction value from the second memory and compare the threshold value corrected with the correction value and the temperature parameter.

13. The image forming apparatus according to claim 10, further comprising:
a second memory configured to store in advance individual information acquired during manufacturing of the fixing unit,
wherein the controller is further configured to determine a correction value based on reference information that serves as a reference for heat capacity and is acquired from a reference fixing unit and based on the individual information acquired from the second memory, and compare the threshold value corrected by the correction value with the temperature parameter.

14. The image forming apparatus according to claim 12, wherein the second memory is provided in the fixing unit.

15. The image forming apparatus according to claim 1,
wherein the feeding rollers are configured to:
start feeding the sheet at a first timing if the temperature parameter exceeds the threshold value; and
start feeding the sheet at a second timing that is after the first timing if the temperature parameter does not exceed the threshold value.

16. The image forming apparatus according to claim 1,
wherein the feeding rollers are configured to:
start feeding the sheet if the temperature parameter exceeds the threshold value; and
if the temperature parameter does not exceed the threshold value, stand by until a temperature detected by the detection unit is higher than or equal to a predetermined value before starting feeding of the sheet.

17. The image forming apparatus according to claim 1,
wherein the image forming unit is configured to:
start forming the image at a first timing if the temperature parameter exceeds the threshold value; and
start forming the image at a second timing that is after the first timing if the temperature parameter does not exceed the threshold value.

18. The image forming apparatus according to claim 1,
wherein the image forming unit is configured to:
start forming the image if the temperature parameter exceeds the threshold value; and
if the temperature parameter does not exceed the threshold value, stand by until a temperature detected by the detection unit is higher than or equal to a predetermined value before starting formation of the image.

19. The image forming apparatus according to claim 1,
wherein a temperature parameter is a temperature gradient or a temperature difference.

20. An image forming apparatus comprising:
feeding rollers configured to feed a sheet;
an image forming unit configured to form an image on the sheet;
a fixing unit configured to fix the image to the sheet, the fixing unit including
a first rotational member,
a second rotational member in contact with the first rotational member to form a nip portion, and
a heater configured to heat at least one of the first rotational member and the second rotational member;
a sensor disposed in proximity to any of the first rotational member, the second rotational member, and the heater, and
a controller configured to acquire a first temperature detected by the sensor, compare a threshold value with a second temperature detected by the sensor after an elapse of a predetermined time since the detection of the first temperature, and control a timing of feeding of the sheet by the feeding rollers or a timing of forming the image by the image forming unit based on a result of judgement of the second temperature and the threshold value determined according to the first temperature.
